(19) United States
(12) Patent Application Publication
(10) Pub. No.: US 2010/0330331 A1
(43) Pub. Date: Dec. 30, 2010

(54) PANEL FOR A DISPLAY AND ELECTRONIC DEVICE USING SAME

(75) Inventors: CHWAN-HWA CHIANG, Shindian (TW); FENG-YUEN DAI, Shindian (TW); QI-JIAN DU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/721,654

(22) Filed: Mar. 11, 2010

(30) Foreign Application Priority Data
Jun. 25, 2009 (CN) 200910303681.8

(51) Int. Cl. B32B 3/30; B32B 15/04; B32B 5/14

(52) U.S. Cl. 428/141; 428/457; 428/170; 428/332

(57) ABSTRACT

A panel for a display comprises a transparent substrate, a color changing coating formed on one surface of the substrate, an anti-reflection coating formed on the color changing coating, and a metallic coating formed on the anti-reflection coating. The substrate is formed with a plurality of light scattering portions whose density gradually changes on one surface of the substrate. An electronic device using the panel is also provided.

### CROSS-REFERENCE TO RELATED APPLICATIONS

This application is related to co-pending U.S. patent application (Attorney Docket No. US 27275), entitled “PANEL FOR A DISPLAY AND ELECTRONIC DEVICE USING SAME”. Such application has the same assignee as the present application. The above-identified application is incorporated herein by reference.

### BACKGROUND

1. Technical Field

The present disclosure relates to a panel for a display, especially to a panel having a reflective appearance and from which colored light and a gradually changing light intensity can be observed, and an electronic device using the panel.

2. Description of Related Art

A panel for a display having a metallic appearance is often considered attractive. A common method of manufacturing the panel is application of a metal coating to a transparent substrate using vacuum deposition. When the panel is used for a display of an electronic device, the metal coating applied to the transparent substrate should not block electromagnetic waves and should also have high light transmission property. However, sometimes, metal coatings can prevent too much light from passing through the panel and be unattractive.

Therefore, there is room for improvement within the art.

### BRIEF DESCRIPTION OF THE FIGURES

Many aspects of the panel for a display and an electronic device using such a panel can be better understood with reference to the following figures. The components in the figures are not necessarily drawn to scale, the emphasis instead being placed upon clearly illustrating the principles of the panel for a display and the electronic device. Moreover, in the drawings like reference numerals designate corresponding parts throughout the several views.

FIG. 1 is a cross-section of an exemplary embodiment of a panel for a display.

FIG. 2 is a schematic view of an exemplary embodiment of an electronic device using the panel of FIG. 1.

### DETAILED DESCRIPTION

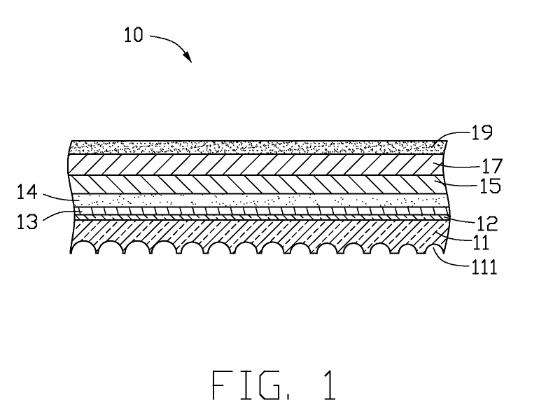

Referring to FIG. 1, in an exemplary embodiment, a panel 10 for a display includes a transparent substrate 11, a color changing coating 12, a light intensity enhancing coating 13, a base coating 14, an anti-reflection coating 15, a metallic coating 17, and a top coating 19 formed on one surface of the substrate 11 in order.

The transparent substrate 11 may be made of transparent plastic selected from a group consisting of polycarbonate (PC), polymethyl methacrylate (PMMA), polystyrene (PS), and styrene-acrylonitrile copolymer. The substrate 11 may have a thickness of about 2-5 mm.

The substrate 11 may be formed with a plurality of light scattering portions 111 on the surface opposite to the surface having the color changing coating 12. The density of the light scattering portions 111 gradually changes from one side to another side or one end to another end of the substrate 11 to create a visual effect of changing light intensity. Each light scattering portion 111 may be a pit having a regular geometric shape, for example, hemispherical, or an irregular geometric shape. The light scattering portions 111 may be of different sizes with, for example, large light scattering portions 111 used in the densest areas and smaller light scattering portions 111 used in the less dense areas. The light scattering portions 111 can scatter light and change the transmission direction of the light and, the dense areas have a stronger light scattering effect. Thus, when colored sidelight sources are located at the side of the substrate 11 of dense areas, these sidelight sources can emit light across the surface of the substrate 11 striking the light scattering portions 111, the light will be scattered to varying degrees depending on the density and the sizes of the scattering portions 111 where the light strikes will create a attractive visual effect of colored light beams of various intensities. Additionally, there will be the effect of the surfaces of the coatings 12-19 gradually changing with the varying light intensities.

The light scattering portions 111 can also be formed on the surface of the substrate 11 formed with the color changing coating 12. The light scattering portions 111 may be formed by printing ink, chemical etching, precise mechanical etching or optical lithography.

The light scattering portions 111 can also be bulges having regular geometric shapes, for example, hemisphere, or irregular geometric shapes and can be formed by printing ink.

The light scattering portions 111 can be arranged in different ways to create unique aesthetic light effects by varying size, shape, density of distribution, location etc. of the light scattering portions 111.

The color changing coating 12 may be an ultraviolent (UV) curing paint coating containing one or more color pigments. The color changing coating 12 may have a thickness of about 1-2 μm. The UV paint may be transparent paint. Each of the one or more pigments may have, for example, a percent of 1.5-2.5% by weight in the color changing coating 12. The pigment can absorb portions of the wavelengths comprising colored light, thus filtering the colored light passing through to create different colors. For example, when the color changing coating 12 contains both red and green pigments, the red pigment micro-articles will change blue light to purple-red light and the green pigment micro-articles will change blue light to cyan light, thereby two colors of light in addition to the blue light are obtained when the blue light passes through the color changing coating 12.

The light intensity enhancing coating 13 may be a silicon dioxide film, a titanium dioxide film or an aluminum oxide film applied, for example, by vacuum evaporation deposition. The light intensity enhancing coating 13 may have a thickness of about 0.1-0.5 μm and a surface roughness of about 0.05-0.1 μm. The silicon dioxide micro-articles, titanium dioxide micro-articles, or aluminum oxide micro-articles contained in the light intensity enhancing coating 13 function as a plurality of convex lenses and concentrate light such that the intensity of the colored light passing through the light intensity enhancing coating 13 is enhanced.

The base coating 14 may be a transparent ultraviolet (UV) curable paint coating or an acrylic resin paint coating. The base coating 14 may have a thickness of about 1-30 μm. The base coating 14 enhances the bonding between the light intensity enhancing coating 13 and the anti-reflection coating 15.

The anti-reflection coating 15 may be a silicon dioxide film or a titanium dioxide film applied, for example, by vacuum evaporation deposition. The anti-reflection coating 15 may have a thickness of about 80-200 nm. The surface roughness of the anti-reflection coating 15 may be less than or equal to about 0.012 μm. The anti-reflection coating 15 has a high refraction index for enhancing the intensity of the colored light passing through, such that the intensity of the colored light passing through the metallic coating 17 is enhanced.

The metallic coating 17 may be formed by vacuum evaporation deposition. The metallic coating 17 has a metallic appearance. The material used for the metallic coating 17 can be indium, tin, indium-tin alloy, aluminum, titanium, titanium carbide, stainless steel or aluminum-silicon alloy. The thickness of the metallic coating 17 is about 0.01-10 μm. The metallic coating 17 can be made nonconductive without blocking excessive radio signals by coating material selection and coating thickness control. When the panel 10 is fixed on an electronic device and the electronic device is not in use, no light is emitted from inside of the electronic device, and, the surface of the metallic coating 17 bonded with the top coating 19 is highly reflective, able to reflect about 20-75% of ambient light. When the electronic device is in use, the light emitted from inside of the electronic device passes through the metallic coating 17 (the metallic coating 17 having light transmittance of 30% or more) with the enhancing effect of the light intensity enhancing coating 13 and the anti-reflection coating 15.

The top coating 19 may be a transparent paint coating having a thickness of about 10-50 μm. The paint used for forming the top coating 19 may be UV curable paint, polyurethane paint, or unsaturated polyester paint. In this exemplary embodiment, UV curable paint is used. The top coating 19 may have high rigidity to protect the metallic coating 17 from abrasion. The paint used for the top coating 19 can be tinted for aesthetic reasons as long as it maintains its transparency.

The top coating 19 may be omitted in applications where abrasion of the panel 10 for a display is not a concern.

The anti-reflection coating 15 and the metallic coating 17 can change places with each other, i.e., the metallic coating 17 is formed on the base coating 14 and the anti-reflection coating 15 is formed on the metallic coating 17.

The base coating 14 is applied as a bonding agent between the anti-reflection coating 15 and the light intensity enhancing coating 13 but may be omitted in applications that allow a bond to be formed by applying the anti-reflection coating 15 directly on the light intensity enhancing coating 13.

The light intensity enhancing coating 13 can be omitted and the base coating 14 is directly formed on the color changing coating 12.

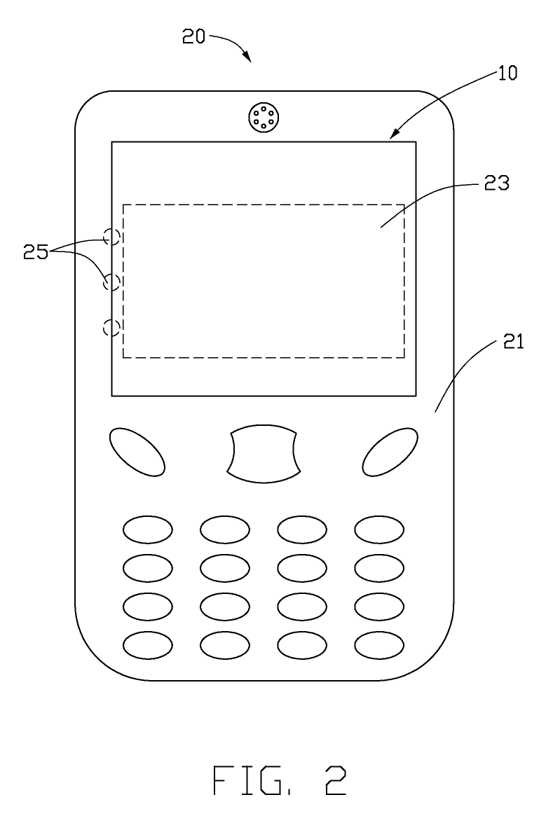

FIG. 2 shows an electronic device 20 including a main body 21 and a panel 10 for a display. The main body 21 includes a display 23 over which the panel 10 is positioned and several sidelight sources 25. The panel 10 includes a transparent substrate 11, a color changing coating 12, a light intensity enhancing coating 13, a base coating 14, an anti-reflection coating 15, a metallic coating 17, and a top coating 19 formed on one surface of the substrate 11 in order. The substrate 11 is formed with a plurality of light scattering portions 111 having gradually changing densities on its one surface. Each light scattering portion 111 may be a pit or a bulge having regular geometric shapes, for example, hemispherical, or irregular geometric shapes. The light scattering portions 111 may be of different sizes with, for example, large light scattering portions 111 used in the densest areas and small light scattering portions 111 used in the less dense areas. The sidelight sources 25 may be colored LEDs optionally positioned beside the substrate 11 to emit light to the light scattering portions 111. Light emitted by the display 23 of the main body 21 passes through the substrate 11, the color changing coating 12, the light intensity enhancing coating 13, the base coating 14, the anti-reflection coating 15, and with the enhancing effect of the light intensity enhancing coating 13 and the anti-reflection coating 15, the light can further pass through the metallic coating 17 and the top coating 19, and with the light scattering of the light scattering portions 111, the colored light emitted by the sidelight sources 25 passes through the coatings 11-19 and, a colored light and a gradually changed light intensity can be observed from the exposed surface of the top coating 19. When the electronic device 20 is not in use, the surface of the metallic coating 17 bonded with the top coating 19 is highly reflective of ambient light.

The exemplary electronic device 20 may be a mobile phone, a PDA, a MP3 or a MP4.

It should be understood, however, that though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A panel for a display, comprising:
a transparent substrate;
a color changing coating formed on one surface of the substrate;
an anti-reflection coating formed on the color changing coating; and
a metallic coating formed on the anti-reflection coating;
wherein the substrate is formed with a plurality of light scattering portions having gradually changing densities on one surface of the substrate.

2. The panel as claimed in claim 1, wherein each light scattering portion is a pit or a bulge having a regular shape or an irregular shape.

3. The panel as claimed in claim 2, wherein the light scattering portions have different sizes.

4. The panel as claimed in claim 3, wherein the densities of the light scattering portions gradually changes from one side to another side or from one end to another end or from the center to the edge of the surface of the substrate with large light scattering portions used in the densest areas and small light scattering portions used in the less dense areas.

5. The panel as claimed in claim 3, wherein the light scattering portions are formed by printing ink, chemical etching, precise mechanical etching or optical lithography.

6. The panel as claimed in claim 1, wherein the color changing coating is a paint coating containing one or more color pigments.

7. The panel as claimed in claim 6, wherein the pigment has a percent of about 1.5-2.5% by weight in the color changing coating.

8. The panel as claimed in claim 1, wherein the anti-reflection coating is silicon dioxide film or titanium dioxide film having a thickness of about 80-200 nm and a surface roughness of less than or equal to about 0.012 μm.

9. The panel as claimed in claim 1, wherein the metallic coating is indium, tin, indium-tin alloy, aluminum, titanium, titanium carbide, stainless steel, or aluminum-silicon alloy formed by vacuum evaporation deposition.

10. The panel as claimed in claim 9, wherein the metallic coating has a thickness of about 0.01-10 μm.

11. The panel as claimed in claim 1, further including a light intensity enhancing coating having a thickness of about 0.1-0.5 μm disposed between the color changing coating and the anti-reflection coating.

12. The panel as claimed in claim 1, further including a light intensity enhancing coating having a thickness of about 0.1-0.5 μm disposed between the color changing coating and the metallic coating.

13. The panel as claimed in claim 11, wherein the light intensity enhancing coating is a silicon dioxide film, a titanium dioxide film or an aluminum oxide film formed by vacuum evaporation deposition; the light intensity enhancing coating has a thickness of about 0.1-0.5 μm and a surface roughness of about 0.05-0.1 μm.

14. The panel as claimed in claim 11, further including a base coating formed between the light intensity enhancing coating and the anti-reflection coating and a top coating formed on the metallic coating.

15. The panel as claimed in claim 12, further including a base coating formed between the light intensity enhancing coating and the metallic coating and a top coating formed on the anti-reflection coating.

16. An electronic device, comprising:
a main body comprising a display and colored sidelight sources; and
a panel positioned over the display;
wherein the panel includes a transparent substrate, a color changing coating formed on one surface of the substrate, an anti-reflection coating formed on the color changing coating; and a metallic coating formed on the anti-reflection coating; the colored sidelight sources are located beside the substrate; the substrate is formed with a plurality of light scattering portions having gradually changing densities on one surface of the substrate; light emitted by the display and colored light emitted by the colored sidelight sources passes through the transparent substrate, the color changing coating, the anti-reflection coating, and the metallic coating.

17. The electronic device as claimed in claim 16, wherein each light scattering portion is a pit or a bulge having a regular shape or an irregular shape, and the light scattering portions are of different sizes.

18. The electronic device as claimed in claim 17, wherein the densities of the light scattering portions gradually changes from one side to another side or from one end to another end or from the center to the edge of the surface of the substrate with large light scattering portions used in the densest areas and small light scattering portions used in the less dense areas.

19. The electronic device as claimed in claim 17, wherein the light scattering portions are formed by printing ink, chemical etching, precise mechanical etching or optical lithography.

20. The electronic device as claimed in claim 1, wherein the anti-reflection coating is silicon dioxide film or titanium dioxide film having a thickness of about 80-200 nm and a surface roughness of less than or equal to about 0.012 μm.
